(19) United States
(12) Patent Application Publication
(10) Pub. No.: US 2012/0248836 A1
(43) Pub. Date: Oct. 4, 2012

(54) SOFA WITH SEAT STRETCHER

(75) Inventors: Christopher Jon Lejcher, Blair, WI (US); Timothy A. Brandtner, Ettrick, WI (US)

(73) Assignee: ASHLEY FURNITURE INDUSTRIES, INC., Arcadia, WI (US)

(21) Appl. No.: 13/304,199

(22) Filed: Nov. 23, 2011

Related U.S. Application Data
(60) Provisional application No. 61/533,031, filed on Sep. 9, 2011.
(60) Provisional application No. 61/469,332, filed on Mar. 30, 2011.
(60) Provisional application No. 61/515,677, filed on Aug. 5, 2011.

(51) Int. Cl. A47C 17/02; B65D 69/00; B23P 19/04; A47C 7/54

(52) U.S. Cl. 297/232; 206/576; 29/428

(57) ABSTRACT

A seat stretcher that can be positioned in the seat box of a sofa to maintain the structural integrity of the seat box against the compressive force of the seat springs. The seat stretcher mounts without fasteners and without additional hardward. In embodiments, the seat stretcher has an offset portion that can be rotated to create space within the seat box for storing cushions or legs within the cavity defined by the seat box.

### PRIORITY CLAIM

This application claims priority to U.S. Provisional Application No. 61/533,031 filed Sep. 9, 2011, entitled “SEAT STRETCHER FOR RTA SOFA”, U.S. Provisional Application No. 61/469,332 filed Mar. 30, 2011, and entitled “FURNITURE ASSEMBLY SYSTEM”, and U.S. Provisional Application No. 61/515,677 filed Aug. 5, 2011, and entitled “FURNITURE ASSEMBLY SYSTEM”, which applications are hereby incorporated by reference in their entirety.

### FIELD OF THE INVENTION

The present invention is generally directed to a seat stretcher for maintaining the structural integrity of a sofa. Specifically, the present invention is directed to an adjustable seat stretcher that maintains the structural integrity of a sofa seat box while allowing the sofa seat box to be used as a storage space.

### BACKGROUND OF THE INVENTION

A conventional sofa generally comprises a seat box or “base” having a having at least one cushion supported over a downwardly deflectable wire webbing that often includes coiled springs. The webbing wired is commonly referred to as the “springs”. The springs are typically stretched across a frame to provide a flexible seating surface in which the springs stretch to allow the seating surface to flex downward in response to a sitting individual to provide a more comfortable seat. The springs are mounted to the upper edge portion of the frame such that the springs are pulled and are under tension such that the seating surface is maintained at level surface without someone seated on the sofa and to return the seat surface to a level surface after someone stands up.

With many seat boxes, the frame is essentially four frame members, typically elongate boards arranged in a rectangular configuration with the springs stretched between at least two of the opposing frame members and typically all four frame members. A manufacturing consideration is that pulling the springs taut and affixing the springs to the frame such that the springs remain taut places considerable strain on the frame. In longer sofas, the distance between the ends of the sofa cause the opposing frame members to bow in near the center of the sofa in response to the strain from the springs. A common approach to addressing the problem is providing intermediate support structure between the opposing frame members and parallel to the ends of the sofa to prevent the opposing frame members from bowing in. The support structures are placed at predetermined points along the interior of the seat box to eliminate any meaningful bowing even when several people are seated on the sofa. An inherent drawback of the approach is the intermediate support structures can substantially increase the weight of the sofa, particularly where support structures comprise boards or wood bracing. The support structure must be displaced from the springs in the regions from the frame so that downward deflection of the springs is not impeded or stopped by the support structures.

An additional consideration is that in many sofas the cushions and legs are placed in the cavity defined by the seat box during transport from the manufacturer to the consumer or retailer. Using the seat box as storage for the cushions and legs reduces the overall bulk of the sofa often allowing the sofa to be more efficiently packed. In addition, the reduced bulk of the sofa allows the sofa to be more easily maneuvered through the structure. The use of the seat box as a storage element is particularly advantageous for ready to assemble furniture systems where the furniture item is delivered as a plurality of disassembled subcomponents. The bulk reduced by storing cushions and other components within the seat box allows the disassembled subcomponents to be even more efficiently packed. However, the inherent tradeoff is that the intermediate support structures used to prevent bowing of the seat box can prevent the cushions or legs from efficiently fitting within the cavity. Particularly for ready to assemble sofas, where it is of great economic advantage to minimize the shipping, it is very advantageous to maximize the available packing space of the seat box. An alternative support is a U-shaped steel tube with flattened ends. Each end has a pair of threaded fasteners, screws or bolts securing the flattened ends to opposing frame members of the seat box. This has provided a viable solution to the weight issue associated with wood support structures. This brace does require several stops to manufacture and install.

Another obvious manufacturing concern is always minimizing the amount of labor and costs of components used in manufacturing furniture. In the arena of mass marketed furniture, the elimination of a single piece of hardware can equate out to very significant cost savings. The known U-shaped seat stretcher brace described above still requires several operations in manufacturing the brace, namely bending the ends to form the U-shape, flattening the ends and drilling two holes on each end. Additionally, four threaded fasteners are needed for attachment to the longer frame members, and the labor to install the brace requires the install of the four fasteners.

### SUMMARY OF THE INVENTION

The present invention is directed to a seat stretcher brace positionable between the opposing frame members of the seat box to resist the compressive force applied by the springs. The seat stretcher can comprise a non-linear elongate support that extends between the opposing frame members replacing the heavier support frame members or fixed non-movable tubular members that are commonly used to prevent bowing. The seat stretcher can be mounted to the seat box without separate fasteners or hardware and such that the seat stretcher can be rotated to provide more space within the cavity defined by the seat box such additional room for cushions and legs or other items can is provided within the seat box cavity. The non-linear shape of the seat stretcher allows the seat stretcher to maintain the structural integrity of the seat box regardless of the orientation of the seat stretcher.

A seat stretcher, according to an embodiment of the present invention, comprises a non-linear elongate body having two ends positioned along a first axis and having an offset portion positioned along a second axis parallel to the first axis. The seat stretcher can further comprise two transition portions oriented along axis transverse to the first and second axis and adapted to join the offset portion to the ends. The seat stretcher is retained in the sofa by boring two holes in the opposing frame members and inserting the ends of the seat stretcher into the corresponding holes. The seat stretcher relies on the compressive force created by the springs to retain the seat stretcher within the holes without the aid of a fastener. In addition, without fasteners, the ends of the seat stretcher can freely rotate within the holes to rotate the offset portion around first axis.

In operation, the seat stretcher can be rotated between at least between a first position in which the offset portion is proximate to a seating surface of the seat box and a second position in which the offset portion is rotated the maximum distance from the seating surface. In the first position, the offset portion is positioned to maximize the amount of useable space within the cavity defined by the seat box allowing the seat box to be used for storage and other purposes. In the second position, the offset portion is positioned permit the seating surface to bow downwards in response to the weight of someone sitting on the seating surface without contacting the offset portion.

A method, according to an embodiment of the present invention, comprises providing a non-linear elongate body having two ends positioned along a first axis and having an offset portion positioned along a second axis parallel to the first axis. The method further comprises boring at least one hole in each opposing frame member of the seat box and positioning the ends of the elongate body in the corresponding holes. According to an embodiment, the method can comprise rotating the elongate body so as to position the offset portion to provide space within the cavity defined by the seat box for cushions and/or legs.

A feature and advantage of an embodiment of the invention is that the seat stretcher is mounted to the frame simply by insertion of two ends into opposing recesses or holes on the frame members adjacent the upper edge of the frame members.

A feature and advantage of embodiments of the invention is that the ends of the brace may be tubular or cylindrical allowing them to readily rotate within recess in the frame members. This can provide two positions for the brace, one position for maximum storage, the other position for allowing maximum deflection without contact with the springs when the springs are deflected downward by loading.

A feature and advantage of an embodiment of the invention is that where the ends of the brace are easily rotatable at the frame members, if the brace is left in the storage maximizing position, when the springs are deflected downwardly by individuals sitting on the sofa, the deflection may easily rotate the offset portion of the brace downwardly toward the lowermost position where maximum deflection of the springs may occur without the brace impeding or contacting the springs.

In an embodiment of the invention a seat stretcher brace has a pair of frame engaging ends for engaging a recess or aperture, a pair of stops on the brace ends for fixing the distance the brace extends into the apertures or recesses.

In an embodiment of the invention, the seat stretcher is secured to the opposing sides of the frame members by insertion of an outermost end portion into the frame members. Said insertion may be by way of a pre-drilled recess or hole or by way of a prong that inbeds into the inwardly facing surfaces of the longer frame members. The prong may have a round shaft permitting rotation which is advantageous, particularly with ready to assemble furniture, as described above.

In an embodiment of the invention a method of assembling a sofa base that is rectangular with two longer frame members and two shorter side members comprises spacing, separating or pulling the longer frame members with respect to each other, so that the seat stretcher brace can be inserted between the two elongate members, closing the spacing between the two elongate members, either by letting the elongate members deflect back or by physically moving them towards their final spacing between each other such that assembly can be completed. If the shorter side members have not been attached, then they are secured to the ends of the two elongate members and the springs are attached.

In an embodiment of the invention

It would be advantageous to maintain the structural integrity of the seat box while further reducing labor and material costs. Moreover, it would be advantageous to maximize the available storage space in the seat box.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The invention can be completely understood in consideration of the following detailed description of various embodiments of the invention in connection with the accompanying drawings, in which:

FIG. 1 is a representative view of a packaged ready to assemble furniture kit for use with a seat stretcher according to an embodiment of the present invention.

FIG. 2 is a perspective view of an assembled furniture item for use with a seat stretcher according to an embodiment of the present invention.

FIG. 3 is a partial exploded view of a ready to assemble furniture kit for use with a seat stretcher according to an embodiment of the present invention.

FIG. 4 is a representative bottom view of a ready to assemble furniture kit showing opening of a seat box for removal of cushions and other furniture components from a cavity defined by a seat box according to an embodiment of the present invention.

FIG. 5 is a a representative bottom view of the ready to assemble furniture kit depicted in FIG. 4 showing rotation of the seat stretchers following removal of the cushions.

FIG. 6 is a diagram view of a ready to assemble furniture kit indicating placements of a plurality of fasteners for assembling the furniture item.

FIG. 7 is a representative perspective view illustrating the placement of the cushions on the assembled furniture item.

FIG. 8 is a perspective view of a seat stretcher according to an embodiment of the present invention.

FIG. 9 is a side view of a seat stretcher depicted in FIG. 8.

FIG. 10 is a partial cross-sectional view of a sofa having a seat stretcher according to an embodiment of the present invention.

FIG. 11 is an exploded perspective view of the sofa of FIG. 10.

FIG. 12 is an enlarged perspective view of the sofa of FIG. 10 showing the seat stretcher according to an embodiment of the present invention.

FIG. 13 is a cross sectional view of a seat stretcher according to an embodiment of the present invention.

FIG. 14 is a bottom view of a representative sofa having a spring according to an embodiment of the present invention.

FIG. 15 is a cross sectional view of a seat stretcher according to an embodiment of the present invention.

FIG. 16 is a perspective view of a seat stretcher according to an embodiment of the present invention.

FIG. 17 is a cross sectional view of the seat stretcher of FIG. 16 according to embodiments of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

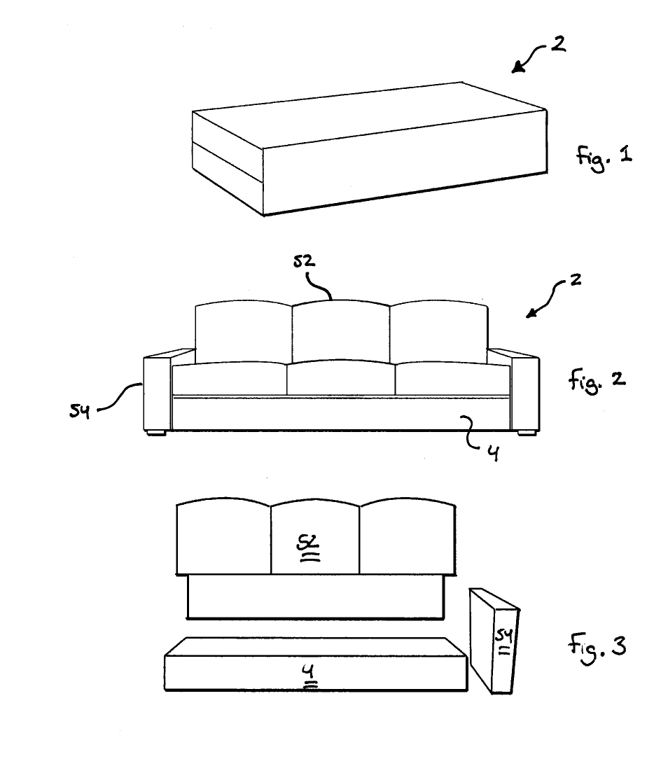

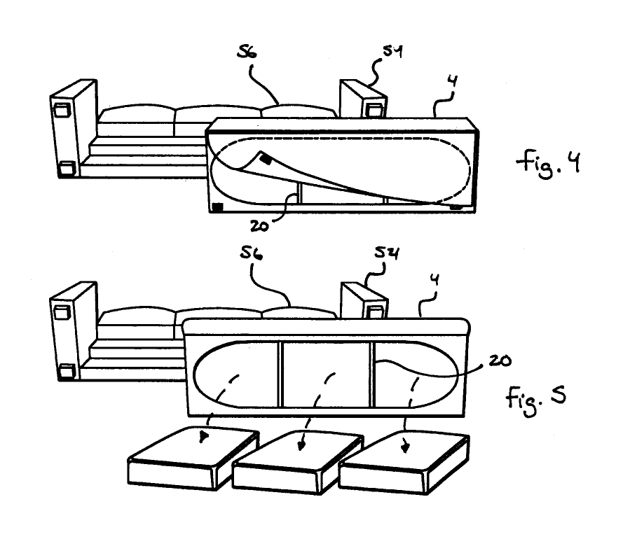

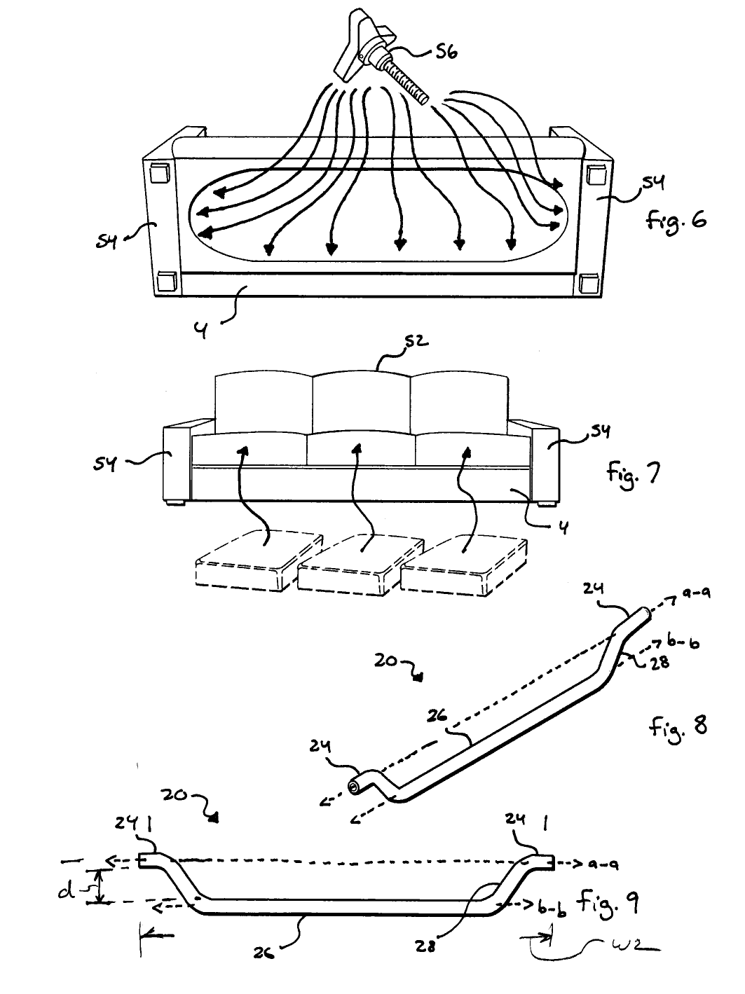

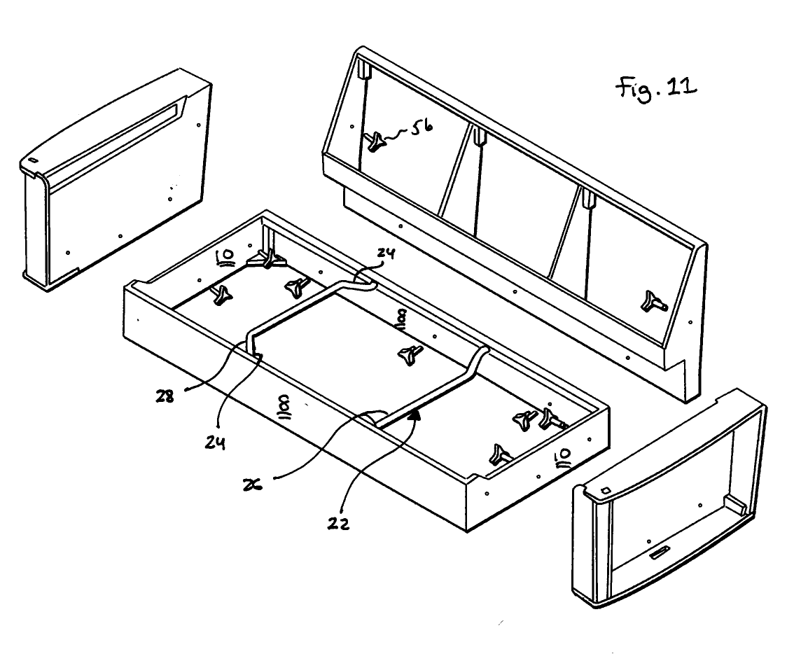

As shown in FIGS. 2-12, 14 a sofa 2, for use with the present invention, comprises a seat box 4 having two opposing frame members 6 between which at least one spring 8 can be stretched and two end frame members 10. As depicted in FIGS. 14, the spring 8 can comprise a cross-webbing configuration in which the spring 8 is mounted to the seat box 4 at a plurality of points on each of the opposing frame members 8. In this configuration, the spring 8 forms a plurality of diamonds that expand or contract to provide a spring force. Other conventional springs utilize coiled springs.

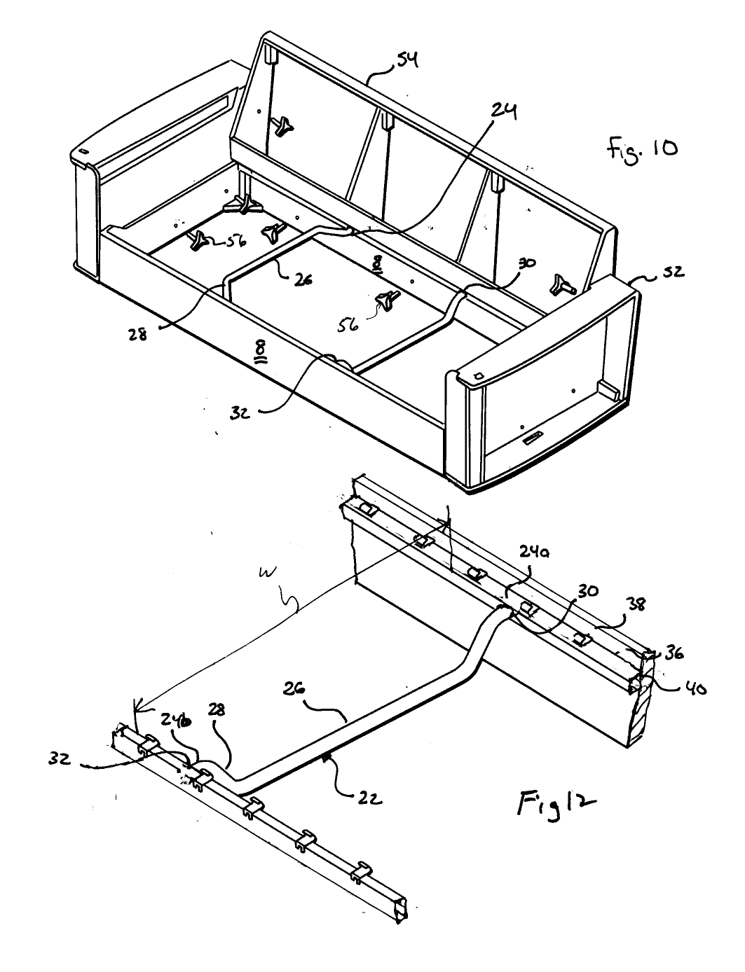

As shown in FIGS. 8-9, a seat stretcher 20, according to an embodiment of the present invention, comprises a non-linear elongate body 22 having two end portions 24 and an offset portion 26. The elongate body 22 can further comprise two transition portions 28 for joining the end portions 24 to the offset portion 26. The non-linear elongate body 22 can comprise either a solid body or have a tubular configuration for reducing the weight of the elongate body 22 without sacrificing the structural integrity of the elongate body 22. Similarly, the non-linear elongate body 22 can comprise a metal such as steel, aluminum, titanium or other high strength, lightweight metals. The end portions 24 of the non-linear elongate body 22 define a first axis a-a, while the offset portion 26 defines a second axis b-b that is parallel to axis a-a. The transition portions 28 each define an axis transverse to axis a-a and axis b-b. In embodiments, the elongate body could be formed out of stampings.

As shown in FIGS. 10-13, one embodiment of the seat stretcher 20 is installed by boring a first hole 30 in one of the opposing longer frame members 8 and a corresponding second hole 32 in the other longer opposing frame member 8. According to an embodiment, the holes 30, 32 can be about 11 mm deep. One end portion 24a of the seat stretcher 20 is insertable into the first hole 30 while the opposite end 24b is insertable into the second hole 32. According to an embodiment, the ends 24a, 24b are retained within the holes 30, 32 without the aid of fasteners and instead are held only by the compressive force created by the tension of the spring 8 on the opposing frame members 8. In this configuration, the offset portion 26 can be rotated around axis b-b. According to an embodiment, a bushing 34 can be fitted to each hole 32, 34 to allow the offset portion 26 to more easily rotate around axis b-b. According to an embodiment, the offset portion 26 can be rotated 270 degrees without contacting the spring 8. The offset distance d may be 2 to 4 inches.

As shown in FIGS. 10-13, according to an embodiment of the present invention, the seat stretcher 20 can be rotated between at least a first position in which the offset portion 26 is positioned the minimum possible distance from the spring 8 and a second position in which the offset portion 26 is rotated the maximum possible distance from the spring 8. In the first position, the offset portion 26 is positioned to maximize the space within the seat box 4 for cushions or other furniture components. In the second position, the offset portion 26 is positioned to provide the spring 8 with the maximum possible expansion distance as the spring 8 stretches in response to a user sitting on the sofa 2. According to an embodiment, the seat stretcher 20 can be rotated into a third position in which the offset portion 26 is positioned in a substantially horizontal position such that the axis b-b intersects center of the opposing frame members 8.

As shown in FIGS. 10-13, the seat box 4 can further comprise a spring rail 36 mounted along the top of each of the opposing frame members 8 having a plurality of mounting brackets 38. The spring 8 is mounted to each of the spring rails 36 via the mounting brackets 38 at a plurality of points along the length of the spring rail 36. According to an embodiment, the holes 32, 34 can be drilled into the corresponding spring rail 36 of the opposing frame members 8 such that the seat stretcher 20 provides the maximum support where the strain on the opposing frame member 8 is the greatest. According to an embodiment, the spring rail 36 can comprise a hardwood cover 40. The longer frame members are separated by a distance w with is shorter than the width w2 of the seat stretcher in this embodiment. “w” may be 24 to 28 inches. w2 may be 0.5 to 2 inches longer.

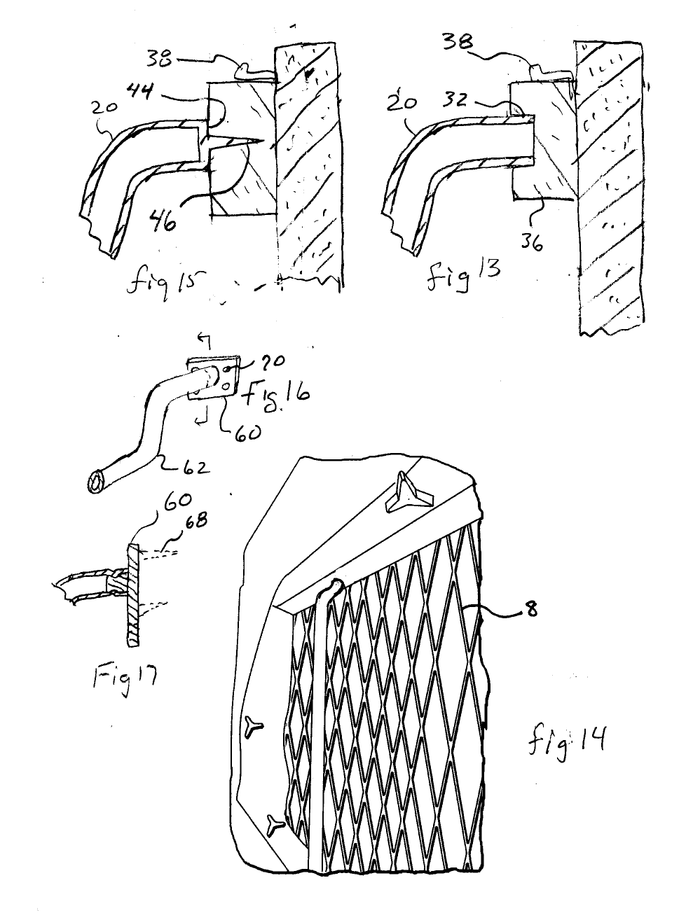

As shown in FIGS. 15, the seat stretcher 42, according to an embodiment, can comprise a stop surface 44, a prong 46 at each end. The two prongs at each end extend collinearly outward in opposite directions. This embodiment may be formed of steel or other metals.

As shown in FIGS. 16 and 17, embodiments of the invention may include brackets to which a curved member 62 with an offset portion is rotatably attached. The brackets can utilize prongs 68 or in certain embodiments may be fastened to the longer frame members with fasteners 70.

According to an embodiment, the sofa 4 can further comprise a back rest 52 and at least one arm rest 54. The sofa 4 can be provided as a ready to assemble kit with the seat box 4, back rest 52 and the arm rest 54 being provided separately with a plurality of fasteners 56 for affixing the seat box 4, back rest 52 and arm rest 54 together. According to an embodiment, the fasteners 56 can threaded through the frame members 6, 10 and into the back rest 52 or arm rest 54.

According to an embodiment, a method for assembling the sofa 4 can comprise providing the seat box 4, the back rest 52, the arm rest 54 and a plurality of manual handled threaded fasteners 56, wherein the seat stretchers 20 are rotated into the first position such that seat cushions and/or legs can be placed within the cavity defined by the seat box 4. The method further comprises opening the seat box 4 and removing the search cushions and/or legs from the seat box cavity. In addition, the method further comprises rotating the seat stretcher 20 into the second position. The method also comprises positioning the arm rests 54 proximate to the end frame members 10 and the back rest 52 proximate to one of the opposing frame members 8 of the seat box 4. Finally, the plurality of fasteners are threaded through the opposing frame member 8 and end frame members 10 to affix the arm rests 54 and back rest 52 to the seat box 4.

Referring to While the invention is amenable to various modifications and alternative forms, specifics thereof have been shown by way of example in the drawings and described in detail. It is understood, however, that the intention is not to limit the invention to the particular embodiments described. On the contrary, the intention is to cover all modifications, equivalents, and alternatives falling within the spirit and scope of the invention as defined by the appended claims.

1. A seat stretcher in combination with a sofa seat box having two opposing frame members arranged a separation distance apart in a rectangular box frame, the seat stretcher comprising:
a non-linear elongate body extending between the two opposing box frame members, the elongate body having a length greater than the separation distance between the opposing box frame members,
the non linear body having two collinear end portions extending in opposite directions defining a first axis and an offset portion,
the end portions extending into the two opposing frame members.

2. The seat stretcher in combination with a sofa seat box of claim 1, wherein the non-linear elongate body comprises a tubular configuration and has a length of at least 26 inches and not more than 30 inches.

3. The seat stretcher in combination with a sofa seat box of claim 1, wherein the end portions are rotatable within the two opposing frame members whereby the offset portion is rotatable between a position proximate to the top of the seat box for maximizing useable space within the seat box and a position away from the top of the seat box for allowing deflection of springs mounted on the sofa seat box.

4. The seat stretcher in combination with a sofa seat box of claim 1, wherein the end portions are tubular and are positioned in bore holes in the two opposing frame members.

5. A sofa kit, comprising:
a seat box having a rectangular frame and comprising two end frame members and two opposing longer frame members defining a cavity, the seat box comprising springs stretched across tops of the opposing frame members;
at least one seat stretcher, the seat stretcher having an elongate body with two end portions and an offset portion, wherein the end portions are rotatably attached to the two opposing longer frame members proximate the tops of the two opposing longer frame members, whereby each seat stretcher is movable between a position adjacent the springs and a position away from the springs, the seat stretcher positioned in the position adjacent the springs; and
a plurality of cushions placed in the cavity.

6. The sofa of claim 5, wherein the elongate body comprises a curved metal tube and the ends of the tube are positioned in bore hole recesses in each of the opposing longer frame members.

7. The sofa kit of claim 5, further comprising a pair of arm rests, the arm rests attachable to the seat box with manual handled threaded fasteners.

8. The sofa kit of claim 5, further comprising instructions for assembling the sofa without using tools, and further comprising a box containing the seat box and the instructions.

9. A method of providing a ready to assemble furniture kit comprising:
providing a seat box having a rectangular frame defined by two end frame members and two opposing frame members each defining at least one bore hole, wherein springs are stretched across the top of the opposing frame members;
positioning between the opposing frame members at least one rotatable seat stretcher having an offset portion movable between a position adjacent the springs to a position away from the springs, the seat stretcher for keeping the two opposing frame members from bowing inwardly under the tension provided by springs on the opposing frame members;
positioning the offset portion in the position adjacent the springs; and
inserting other kit components into a cavity defined by the rectangular frame of the seat box.

10. The method of claim 9, further comprising:
packaging the seat box in a cardboard box.

11. The method of claim 10, further comprising:
providing a back rest and a plurality of fasteners and instructions for assembly without tools in the box.

12. A method of assembly of a sofa base, the sofa base being rectangular with two elongate frame members with inwardly facing surfaces and two shorter end frame members, the method comprising:
positioning a seat stretcher brace in between the two elongate frame members, the seat stretcher having a pair of outermost end portions extending in opposite directions, the outermost end portions being collinear, an offset portion extending between and connecting the two end portions, the end portions and offset portion integral;
inserting the end portions into the elongate frame members such that they extend beyond the inwardly facing surfaces and without using separate fasteners;
attaching the springs to the two elongate frame members at a plurality of locations along each elongate frame member

13. The method of claim 12 further comprising the step of drilling into each of the elongate frame members and inserting the end portions into openings provided by the drilling.

14. The method of claim 13 wherein the elongate frame members each have an upper edge thickness wherein the drilling comprises drilling only through a portion of the upper edge thickness and the end portions each have a circular end portion sized for the opening and the circular end portions bottom out in the openings.

15. The method of claim 12 and wherein the step of inserting the end portions into the elongate frame member comprises insertion of at least one pointed prong of each end portion into each of the inwardly facing surfaces.
